(19) United States
(12) Patent Application Publication
(10) Pub. No.: US 2022/0390967 A1
(43) Pub. Date: Dec. 8, 2022

(54) PUMPING SYSTEM AND METHOD FOR PROVIDING CONSTANT FLUID FLOW

(71) Applicant: Caterpillar Inc., Peoria, IL (US)

(72) Inventor: Daniel Peter Sergison, East Peoria, IL (US)

(21) Appl. No.: 17/303,542

(22) Filed: Jun. 2, 2021

(51) Int. Cl. G05D 7/06

(52) U.S. Cl. CPC G05D 7/0682

(57) ABSTRACT

A pumping system includes a first pump for delivering a fluid. The pumping system also includes a flow hose for receiving the fluid from the first pump. The pumping system further includes a compression mechanism disposed proximate to the flow hose for partially compressing the flow hose. The compression mechanism includes at least one of a hydraulic compression system and a mechanical compression system. The pumping system includes a controller communicably coupled with the first pump. The controller is configured to detect a flow reduction of the fluid exiting the first pump. The controller is also configured to activate the compression mechanism for partially compressing the flow hose in order to reduce a volume of the flow hose during the flow reduction of the fluid exiting the first pump. The partial compression of the flow hose provides a constant fluid flow at an outlet of the flow hose.

### TECHNICAL FIELD

The present disclosure relates to a pumping system and a method for providing constant fluid flow at an exit of a flow hose of the pumping system.

### BACKGROUND

Pumps, such as peristaltic pumps or other such pumps that provide a non-constant outputs are used in a variety of applications. For example, such pumps may be used to pump materials such as liquid concrete and/or other viscous fluids/slurries containing fragments like mud, sand, sand sized particles, aggregates, etc. Such pumps may be used in three-dimensional (3D) printing applications or other similar applications. For example, large sized pumps may be used in 3D printing in construction applications. However, such applications require a constant output flow from the pumps.

The pumps that are currently being used to pressurize fluids containing fragments provide a pulsating or non-constant output which is not desirable. Further, flow surges from such pumps may not be desirable. Moreover, some passively controlled accumulators are available in the industry that can be used for damping output pulsations. However, such accumulators do not perform satisfactorily with non-Newtonian fluids such as cementitious mixtures containing aggregates, or other such fluids which have non-linear coefficient of friction.

KR101916892B1 describes a fast groove joint capable of easily homogenizing internal pressure of a pipe. According to one embodiment of the present invention, the fast groove joint comprises a clamp having a ring gasket inserted therein to connect a pipe disposed in series in a longitudinal direction and a coupling flange formed on both sides. Further, a protruding part is inserted into the clamp that protrudes towards a central part. Moreover, the ring gasket has a corrugated part which includes a groove part formed at the protruding part in a groove shape to allow gas or liquid to flow therein for aligning the position of the pipe so as to maintain straightness of the pipe.

### SUMMARY OF THE DISCLOSURE

In one aspect of the present disclosure, a pumping system is provided. The pumping system includes a first pump for delivering a fluid. The pumping system also includes a flow hose for receiving the fluid from the first pump. The pumping system further includes a compression mechanism disposed proximate to the flow hose for partially compressing the flow hose. The compression mechanism includes at least one of a hydraulic compression system and a mechanical compression system. The pumping system includes a controller communicably coupled with the first pump. The controller is configured to detect a flow reduction of the fluid exiting the first pump. The controller is also configured to activate the compression mechanism for partially compressing the flow hose in order to reduce a volume of the flow hose during the flow reduction of the fluid exiting the first pump. The partial compression of the flow hose provides a constant fluid flow at an outlet of the flow hose.

In another aspect of the present disclosure, a method for providing a constant fluid flow of a fluid at an outlet of a flow hose is provided. The method includes detecting, by a controller of a pumping system, a flow reduction of the fluid exiting a first pump of the pumping system. The first pump delivers the fluid towards the flow hose. The method also includes activating, by the controller, a compression mechanism of the pumping system during the flow reduction of the fluid exiting the first pump. The compression mechanism is disposed proximate to the flow hose for partially compressing the flow hose. Further, the compression mechanism includes at least one of a hydraulic compression system and a mechanical compression system. The method further includes compressing, partially, the flow hose by the compression mechanism in order to reduce a volume of the flow hose based on the activation of the compression mechanism. The partial compression of the flow hose by the compression mechanism provides the constant fluid flow at the outlet of the flow hose.

Other features and aspects of this disclosure will be apparent from the following description and the accompanying drawings.

### BRIEF DESCRIPTION OF THE DRAWINGS

FIG. 1 is a block diagram of a pumping system, according to examples of the present disclosure;

FIG. 2 illustrates a flow hose disposed adjacent to a bladder inside a tube associated with the pumping system of FIG. 1, according to examples of the present disclosure;

FIG. 3 illustrates an end view of the flow hose, the bladder, and the containing tube of FIG. 2, according to examples of the present disclosure;

FIG. 4 illustrates the flow hose disposed adjacent to the bladder associated with the pumping system of FIG. 1, according to examples of the present disclosure; and

FIG. 5 illustrates the flow hose disposed within the bladder associated with the pumping system of FIG. 1, according to examples of the present disclosure;

FIG. 6 illustrates a perspective view of a pair of plates disposed proximate to the flow hose associated with the pumping system of FIG. 1, according to examples of the present disclosure; and

FIG. 7 illustrates a flowchart for a method for providing a constant fluid flow of a fluid at an exit of the flow hose, according to examples of the present disclosure.

### DETAILED DESCRIPTION

Wherever possible, the same reference numbers will be used throughout the drawings to refer to the same or the like parts. Wherever possible, corresponding, or similar reference numbers will be used throughout the drawings to refer to the same or corresponding parts.

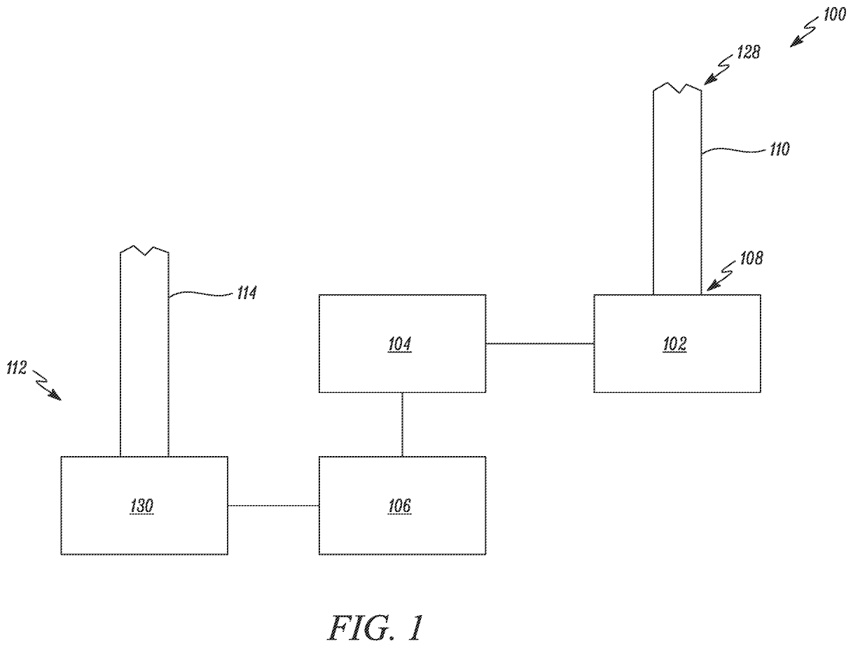

FIG. 1 is a block diagram of a pumping system 100. The pumping system 100 may be used in a variety of applications including, but not limited to, three-dimensional printing. The pumping system 100 may be used in construction applications, food manufacturing, medical applications, electronic components manufacturing, and the like. It should be noted that the present disclosure is not limited by an application of the pumping system 100.

The pumping system 100 includes a first pump 102 for delivering a fluid. In some examples, the fluid may contain fragments of material therein. The fluid may include viscous fluids, including highly viscous fluids, or slurries. In an example, the fluid may include a non-Newtonian fluid. For example, the fluid may include cementitious fluids or liquid concrete. Further, the fragments of material may include aggregates, sand, mud, sand-sized particles, and the like. In an example, the first pump 102 may include a positive displacement pump, such as a roller pump. For example, the first pump 102 includes a peristaltic pump. Alternatively, the first pump 102 may include any other type of pump that provides a pulsating or non-constant fluid output, without any limitations.

The first pump 102 may include a flexible tubing (not shown) disposed within a pump casing (not shown). The fluid to be pumped is contained within the flexible tubing. Further, the first pump 102 may include a rotor (not shown) having one or more rollers (not shown) attached at an external circumference thereof. The rollers compress the flexible tubing as they rotate such that a portion of the flexible tubing that is in compression is closed, forcing the fluid to move through the flexible tubing. It should be noted that a design and an arrangement of the first pump 102 described herein is exemplary, and the first pump 102 may include any other design or arrangement, without any limitations. Further, the first pump 102 includes a sensor 104 communicably coupled with a controller 106. In some examples, the sensor 104 generates an input signal indicative of a displacement of the first pump 102 or a pressure proximate an outlet 108 of the first pump 102. For example, the sensor 104 may be used to indicate a timing at which there may be a pulsation event that causes flow reduction of the fluid exiting the first pump 102.

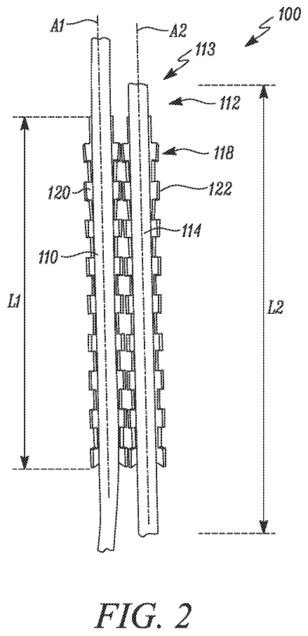

The first pump 102 delivers the fluid towards a flow hose 110 (shown in FIG. 2). As shown in FIG. 2, the pumping system 100 includes the flow hose 110 for receiving the fluid from the first pump 102. The flow hose 110 includes a flexible hose. The flow hose 110 is manufactured of a flexible material. The flow hose 110 may be made of a metal or a non-metal such as plastics or rubber. For examples, the flow hose 110 may be made of nylon, polyurethane, polyethylene, Polyvinyl Chloride (PVC), Polytetrafluoroethylene (PTFE), and the like.

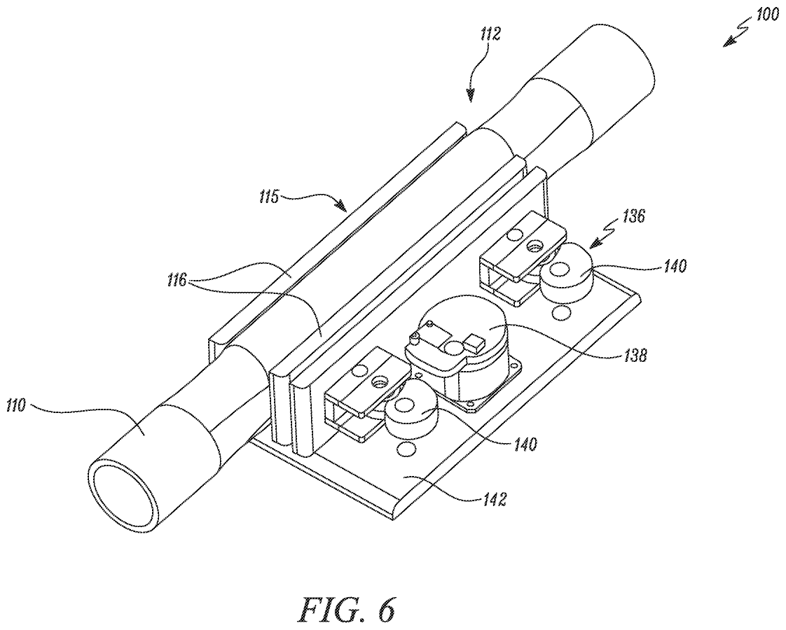

Further, the pumping system 100 includes a compression mechanism 112 disposed proximate to the flow hose 110 for partially compressing the flow hose 110. The compression mechanism 112 includes at least one of a hydraulic compression system 113 (shown in FIGS. 2 to 5) and a mechanical compression system 115 (shown in FIG. 6). The hydraulic compression system 113 includes a bladder 114. As shown in the accompanying figures, the bladder 114 extends along a length of the flow hose 110. The bladder 114 is embodied as a flexible hose herein. In some examples, a material of the bladder 114 may be similar to the material of the flow hose 110. Alternatively, the material of the bladder 114 may be different from the material of the flow hose 110. Further, in an example, a cross-sectional area of the flow hose 110 may be similar to a cross-sectional area of the bladder 114. Alternatively, the cross-sectional area of the flow hose 110 may be different from the cross-sectional area of the bladder 114.

Further, the hydraulic compression system 113 includes a tube 118 for receiving the flow hose 110 and the bladder 114. Further, the length of the flow hose 110 is generally greater than a length “L1” of the tube 118 but lesser than a length “L2” of the bladder 114. Moreover, the length “L2” of the bladder 114 is greater than the length “L1” of the tube 118. In the illustrated example, a first axis “A1” defined by the flow hose 110 is substantially parallel to a second axis “A2” defined by the bladder 114 such that the flow hose 110 is disposed adjacent to the bladder 114.

The tube 118 includes a first portion 120 and a second portion 122 that is coupled to the first portion 120. For example, the first and second portions 120, 122 may be connected to each other by hinges. The tube 118 includes a circular cross-section herein. Alternatively, the tube 118 may have any other cross-section, such as a rectangular cross-section or a square cross-section. In some examples, the tube 118 may be made of a metallic material. Alternatively, the tube 118 may be made of a non-metallic material. In the illustrated example, the first and second portions 120, 122 are semi-circular in shape such that the first and second portions 120, 122 when coupled form the tube 118.

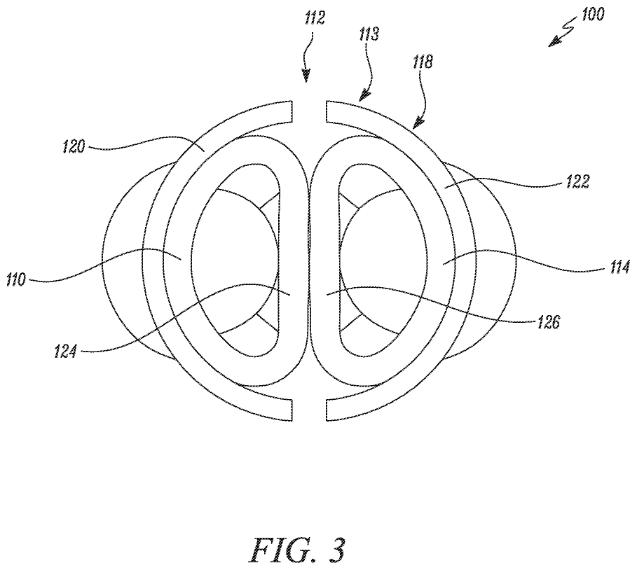

The tube 118 is embodied as a rigid tube. Further, as shown in FIG. 3, the tube 118 acts as a mechanical clamp that holds and slightly compresses the flow hose 110 and the bladder 114 therein. Specifically, when the first and second portions 120, 122 are coupled to each other, the flow hose 110 and the bladder 114 are slightly compressed within the tube 118 at contact portions 124, 126, respectively. In other examples, a design and a size of the tube 118 may be such that the flow hose 110 and the bladder 114 are not compressed by the tube 118.

Referring again to FIG. 1, the pumping system 100 includes the controller 106 communicably coupled with the first pump 102. The controller 106 detects the flow reduction of the fluid exiting the first pump 102. More particularly, the controller 106 receives the input signal from the sensor 104 for detecting the flow reduction of the fluid exiting the first pump 102. Further, the controller 106 activates the compression mechanism 112 for partially compressing the flow hose 110 in order to reduce a volume of the flow hose 110 during the flow reduction of the fluid exiting the first pump 102. The partial compression of the flow hose 110 provides a constant fluid flow at an outlet 128 of the flow hose 110. More particularly, the controller 106 activates the compression mechanism 112 based on receipt of the input signal.

In the illustrated example, the bladder 114 is inflated to partially compress the flow hose 110 in order to reduce the volume of the flow hose 110. Accordingly, the hydraulic compression system 113 includes a second pump 130 communicably coupled with the controller 106 for delivering a pressurized hydraulic fluid towards the bladder 114 during the flow reduction of the fluid exiting the first pump 102. The pressurized hydraulic fluid inflates the bladder 114 for reducing the volume of the flow hose 110. More particularly, the controller 106 actuates the second pump 130 to deliver the pressurized hydraulic fluid towards the bladder 114. The hydraulic fluid may include water, or any other hydraulic fluid, without limiting the scope of the present disclosure. The pressurized hydraulic fluid may be delivered to the bladder 114 at a controlled pressure and a controlled flow rate.

The bladder 114 compresses the flow hose 110 along the length of the flow hose 110. Specifically, the cross-section of the flow hose 110 reduces as the bladder 114 compresses the flow hose 110. The compression of the flow hose 110 by the bladder 114 causes the fluid within the flow hose 110 to be compressed. Further, a compressed volume of the fluid is squeezed out through the outlet 128 of the flow hose 110 when the first pump 102 is outputting less amount of fluid, thus adding to fluid output for providing a constant output of the fluid at the outlet 128 of the flow hose 110.

Moreover, the controller 106 releases the compression mechanism 112 in the controlled manner during a normal flow from the first pump 102. More particularly, the controller 106 may control the second pump 130 to reduce or stop the flow of the pressurized hydraulic fluid towards the bladder 114. The flow of the pressurized hydraulic fluid is reduced slowly and in a controlled manner. The reduction in the flow of the pressurized hydraulic fluid causes the flow hose 110 to return to its original position thus subtracting some flow and providing the constant output of the fluid at the outlet 128 of the flow hose 110.

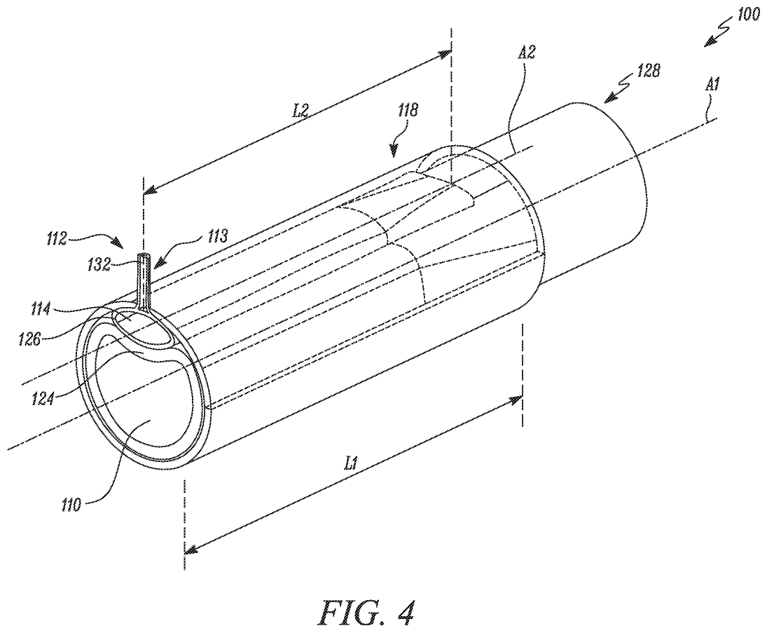

FIG. 4 illustrates another exemplary hydraulic compression system 113 associated with the pumping system 100. In this example, the hydraulic compression system 113 includes the bladder 114. The bladder 114 includes an inlet portion 132 that receives the pressurized hydraulic fluid from the second pump 130 (see FIG. 1). The bladder 114 may include an oval cross-section or a circular cross-section. The bladder 114 and the flow hose 110 are made of a flexible material. Further, the bladder 114 and the flow hose 110 may be made of a metallic material or a non-metallic material.

Further, the flow hose 110 and the bladder 114 are received within the tube 118. The tube 118 includes a circular cross-section herein. As illustrated, the length “L2” of the bladder 114 is lesser than the length “L1” of the tube 118. Further, when the flow hose 110 and the bladder 114 are received within the tube 118, the flow hose 110 and the bladder 114 may be partially compressed at the contact portions 124, 126. Moreover, as illustrated, the first axis “A1” defined by the flow hose 110 is substantially parallel to the second axis “A2” defined by the bladder 114 such that the flow hose 110 is disposed adjacent to the bladder 114. A flow of the pressurized hydraulic fluid through the bladder 114 may partially compress and vary the volume of the flow hose 110 for maintaining the constant output of the fluid at the outlet 128 of the flow hose 110.

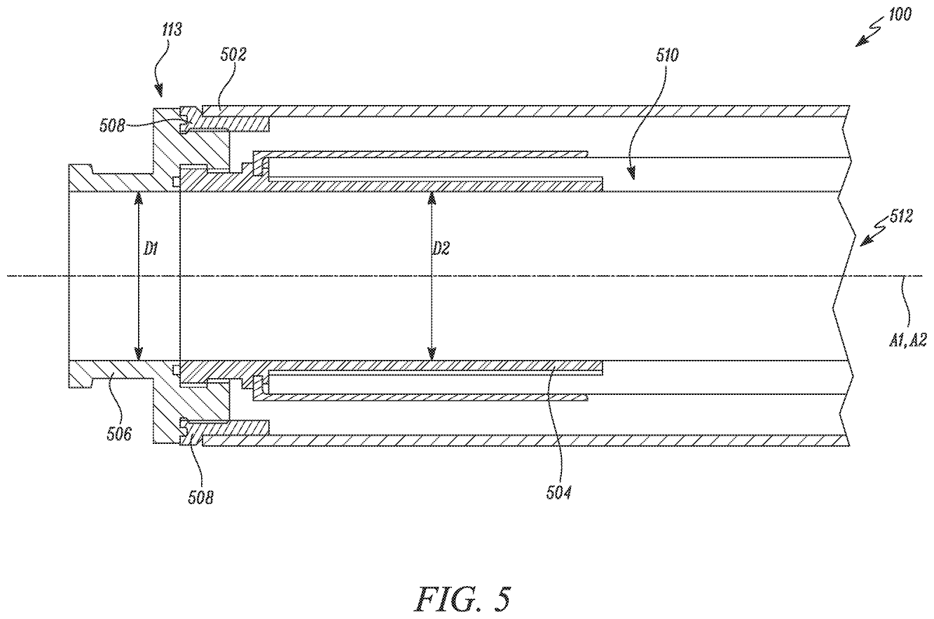

FIG. 5 illustrates yet another exemplary hydraulic compression system 113 associated with the pumping system 100. In this example, the hydraulic compression system 113 includes a bladder 502. As illustrated herein, a first axis “A1” defined by a flow hose 504 is substantially parallel to a second axis “A2” defined by the bladder 502 such that the flow hose 504 is concentrically disposed within the bladder 502. The bladder 502 and the flow hose 504 have a circular cross-section. The flow hose 504 is made of a flexible material. Further, the bladder 502 may be made of a flexible material or a rigid material. Moreover, the flow hose 504 and the bladder 502 may be made of a metallic material or a non-metallic material.

As illustrated, the hydraulic compression system 113 includes a clamp 506 that couples the flow hose 504 with the bladder 502 so that the flow hose 504 can be concentrically received within the bladder 502. The clamp 506 is coupled with the bladder 502 using mechanical fasteners 508. Further, the clamp 506 defines an internal diameter “D1” that aligns with an inner diameter “D2” of the flow hose 504 so that the fluid can flow through the flow hose 504.

It should be noted that, in the illustrated example, the fluid flows through the flow hose 504 whereas the pressurized hydraulic fluid flows through a hollow space 510 that is defined between the flow hose 504 and the bladder 502. Further, the flow of the pressurized hydraulic fluid through the bladder 502 may partially compress and vary the volume of the flow hose 504 for maintaining the constant output of the fluid at an outlet 512 of the flow hose 504.

FIG. 6 illustrates the exemplary mechanical compression system 115 associated with the pumping system 100. The mechanical compression system 115 includes one or more compression plates 116. More particularly, the mechanical compression system 115 includes the pair of compressions plates 116. In another example, the mechanical compression system 115 may include a single compression plate 116, without any limitations. The compression plates 116 are rectangular in shape.

The mechanical compression system 115 also includes an actuating mechanism 136 for moving the one or more compression plates 116 for partially compressing the flow hose 110. The actuating mechanism 136 is communicably coupled with the controller 106 (see FIG. 1). The actuating mechanism 136 includes an electric motor 138 or an actuator. In the illustrated example, the actuating mechanism 136 include the electric motor 138, one or more cams 140, and one or more gear drives (not shown). The electric motor 138, the cams 140, and the gear drives are supported on a support structure 142. The electric motor 138 receives control signals from the controller 106 during the flow reduction of the fluid exiting the first pump 102 (see FIG. 1) of the pumping system 100. More particularly, based on the flow reduction of the fluid exiting the first pump 102, the electric motor 138 is actuated. The actuation of the electric motor 138 causes the compression plates 116 to move towards each other, thereby compressing the flow hose 110 and reducing the volume of the flow hose 110. In an example, both the compression plates 116 may be movable for compressing the flow hose 110. Alternatively, any one compression plate 116 may be movable for compressing the flow hose 110.

The compression of the flow hose 110 by the bladder 114 causes the fluid within the flow hose 110 to be compressed. Further, a compressed volume of the fluid present within the flow hose 110 is squeezed out of the flow hose 110 when the first pump 102 is outputting less amount of fluid, thus adding to fluid output for providing the constant output of the fluid.

Moreover, the controller 106 controls the compression plates 116 so that the compression plates 116 release the flow hose 110 in a controlled manner during the normal flow from the first pump 102. More particularly, the controller 106 may control the electric motor 138 to move the compression plates 116 away from each other. The compression plates 116 are moved slowly and in the controlled manner. As the flow hose 110 is released to return to its original position, some amount of fluid flow is subtracted thereby providing the constant output of the fluid exiting the flow hose 110.

In another example, the actuating mechanism 136 may include the actuator. For example, the actuator may include a hydraulic actuator or a pneumatic actuator. The actuator may be communicably coupled to the controller 106. The actuator may move the compression plates 116 for compressing the flow hose 110. In an example, the actuator may move both the compression plates 116. Alternatively, the actuator may move any one compression plate 116.

The controller 106 may be embodied as a single microprocessor or multiple microprocessors for receiving signals from various components of the pumping system 100. Numerous commercially available microprocessors may be configured to perform the functions of the controller 106. It should be appreciated that the controller 106 may embody a microprocessor capable of controlling numerous functions. A person of ordinary skill in the art will appreciate that the controller 106 may additionally include other components and may also perform other functions not described herein.

### INDUSTRIAL APPLICABILITY

The present disclosure relates to the pumping system 100. The pumping system 100 can be used for pumping of highly viscous fluids or slurries that have fragments of various sizes present therein. A tendency of the fragments to lock with each other makes them difficult to move through the flow hose 110, 504. The pumping system 100 eliminates this challenge by partially compressing the flow hose 110, 504. The compression mechanism 112 in the form of the bladder 114, 502 and the compression plates 116 acts as an active accumulator device that compresses the flow hose 110, 504 in order to vary the cross-section of the flow hose 110, 504. The compression of the flow hose 110, 504 forces the compressed volume of the fluid out of the flow hose 110, 504 for maintaining constant fluid flow at the exit of the flow hose 110, 504.

The pumping system 100 includes the sensor 104 that assists in activating the compression mechanism 112 for compression of the flow hose 110, 504 when the first pump 102 is outputting less amount of material, thus maintaining the constant output at the outlet 128, 512 of the flow hose 110, 504. Further, the controller 106 releases the compression mechanism 112 in the controlled manner when the first pump 102 is outputting the normal flow, thus subtracting some amount of the fluid flow, and providing the constant output at the outlet 128, 512 of the flow hose 110, 504.

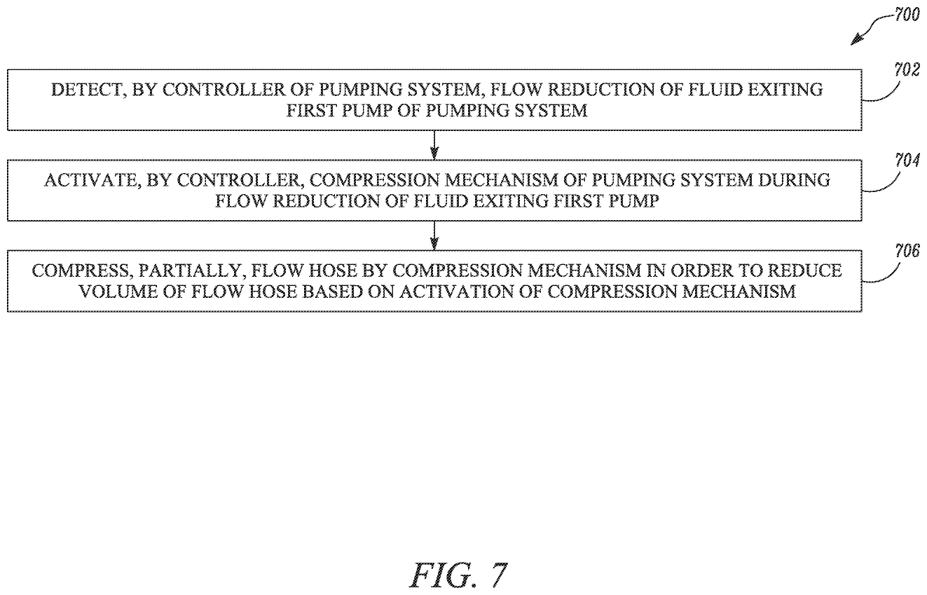

FIG. 7 illustrates a flowchart for a method 700 for providing the constant fluid flow of the fluid at the outlet 128, 512 of the flow hose 110, 504. At step 702, the controller 106 of the pumping system 100 detects the flow reduction of the fluid exiting the first pump 102 of the pumping system 100. The first pump 102 delivers the fluid towards the flow hose 110, 504. Moreover, the controller 106 receives the input signal from the sensor 104 for detecting the flow reduction of the fluid exiting the first pump 102. The sensor 104 generates the input signal indicative of the displacement of the first pump 102 or the pressure proximate the outlet 108 of the first pump 102. The sensor 104 is communicably coupled with the controller 106. The controller 106 activates the compression mechanism 112 based on receipt of the input signal.

At step 704, the controller 106 activates the compression mechanism 112 of the pumping system 100 during the flow reduction of the fluid exiting the first pump 102. The compression mechanism 112 is disposed proximate to the flow hose 110, 504 for partially compressing the flow hose 110, 504. Further, the compression mechanism 112 includes the hydraulic compression system 113 or the mechanical compression system 115. In one example, the flow hose 110 and the bladder 114 are received within the tube 118. Further, the flow hose 110 is positioned adjacent to the bladder 114 such that the first axis “A1” defined by the flow hose 110 is substantially parallel to the second axis “A2” defined by the bladder 114. Alternatively, the flow hose 504 is positioned concentrically within the bladder 502 such that the first axis “A1” defined by the flow hose 504 is coaxial with the second axis “A2” defined by the bladder 502.

Moreover, in an example, the second pump 130 of the hydraulic compression system 113 that is communicably coupled with the controller 106 delivers the pressurized hydraulic fluid towards the bladder 114, 502 of the hydraulic compression system 113 during the flow reduction of the fluid exiting the first pump 102. The pressurized hydraulic fluid inflates the bladder 114, 502 for reducing the volume of the flow hose 110, 504. In another example, the one or more compression plates 116 of the mechanical compression system 115 are moved by the actuating mechanism 136 of the mechanical compression system 115 for partially compressing the flow hose 110. The actuating mechanism 136 is communicably coupled with the controller 106. The actuating mechanism 136 may include the electric motor 138 and/or the actuator.

At step 706, the flow hose 110, 504 is partially compressed by the compression mechanism 112 in order to reduce the volume of the flow hose 110, 504 based on the activation of the compression mechanism 112. The partial compression of the flow hose 110, 504 by the compression mechanism 112 provides the constant fluid flow at the outlet 128, 512 of the flow hose 110, 504. Further, the compression mechanism 112 is released in the controlled manner during the normal flow from the first pump 102.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof

What is claimed is:

1. A pumping system comprising:
a first pump for delivering a fluid;
a flow hose for receiving the fluid from the first pump;
a compression mechanism disposed proximate to the flow hose for partially compressing the flow hose, the compression mechanism including at least one of a hydraulic compression system and a mechanical compression system; and
a controller communicably coupled with the first pump; wherein the controller is configured to:
detect a flow reduction of the fluid exiting the first pump; and
activate the compression mechanism for partially compressing the flow hose in order to reduce a volume of the flow hose during the flow reduction of the fluid exiting the first pump, wherein the partial compression of the flow hose provides a constant fluid flow at an outlet of the flow hose.

2. The pumping system of claim 1, wherein the controller is further configured to release the compression mechanism in a controlled manner during a normal flow from the first pump.

3. The pumping system of claim 1, wherein the first pump includes a sensor communicably coupled with the controller, the sensor is configured to generate an input signal indicative of at least one of a displacement of the first pump and a pressure proximate an outlet of the first pump.

4. The pumping system of claim 3, wherein the controller is further configured to:
receive the input signal from the sensor for detecting the flow reduction of the fluid exiting the first pump; and
activate the compression mechanism based on receipt of the input signal.

5. The pumping system of claim 1, wherein the hydraulic compression system includes a bladder, wherein a first axis defined by the flow hose is substantially parallel to a second axis defined by the bladder such that the flow hose is disposed adjacent to the bladder.

6. The pumping system of claim 5, wherein the first axis defined by the flow hose is coaxial with the second axis defined by the bladder such that the flow hose is concentrically disposed within the bladder.

7. The pumping system of claim 5, wherein the hydraulic compression system includes a second pump communicably coupled with the controller for delivering a pressurized hydraulic fluid towards the bladder during the flow reduction of the fluid exiting the first pump, wherein the pressurized hydraulic fluid inflates the bladder for reducing the volume of the flow hose.

8. The pumping system of claim 5, wherein the hydraulic compression system includes a tube for receiving the flow hose and the bladder.

9. The pumping system of claim 1, wherein the mechanical compression system includes:
a pair of compression plates; and
an actuating mechanism for moving the one or more compression plates for partially compressing the flow hose, wherein the actuating mechanism is communicably coupled with the controller.

10. The pumping system of claim 9, wherein the actuating mechanism includes at least one of an electric motor and an actuator.

11. A method for providing a constant fluid flow of a fluid at an outlet of a flow hose, the method comprising:
detecting, by a controller of a pumping system, a flow reduction of the fluid exiting a first pump of the pumping system, wherein the first pump delivers the fluid towards the flow hose;
activating, by the controller, a compression mechanism of the pumping system during the flow reduction of the fluid exiting the first pump, wherein the compression mechanism is disposed proximate to the flow hose for partially compressing the flow hose, and wherein the compression mechanism includes at least one of a hydraulic compression system and a mechanical compression system; and
compressing, partially, the flow hose by the compression mechanism in order to reduce a volume of the flow hose based on the activation of the compression mechanism, wherein the partial compression of the flow hose by the compression mechanism provides the constant fluid flow at the outlet of the flow hose.

12. The method of claim 11 further comprising releasing the compression mechanism in a controlled manner during a normal flow from the first pump.

13. The method of claim 11 further comprising generating, by a sensor, an input signal indicative of at least one of a displacement of the first pump and a pressure proximate an outlet of the first pump, wherein the sensor is communicably coupled with the controller.

14. The method of claim 13 further comprising:
receiving, by the controller, the input signal from the sensor for detecting the flow reduction of the fluid exiting the first pump; and
activating, by the controller, the compression mechanism based on receipt of the input signal.

15. The method of claim 11 further comprising delivering, by a second pump of the hydraulic compression system that is communicably coupled with the controller, a pressurized hydraulic fluid towards a bladder of the hydraulic compression system during the flow reduction of the fluid exiting the first pump, wherein the pressurized hydraulic fluid inflates the bladder for reducing the volume of the flow hose.

16. The method of claim 15 further comprising receiving the flow hose and the bladder within a tube.

17. The method of claim 16 further comprising positioning the flow hose adjacent to the bladder such that a first axis defined by the flow hose is substantially parallel to a second axis defined by the bladder.

18. The method of claim 17 further comprising positioning the flow hose concentrically within the bladder such that the first axis defined by the flow hose is coaxial with the second axis defined by the bladder.

19. The method of claim 11 further comprising moving, one or more compression plates of the mechanical compression system, by an actuating mechanism of the mechanical compression system for partially compressing the flow hose, wherein the actuating mechanism is communicably coupled with the controller.

20. The method of claim 19, wherein the actuating mechanism includes at least one of an electric motor and an actuator.
